(19) United States
(12) Patent Application Publication
(10) Pub. No.: US 2002/0132660 A1
(43) Pub. Date: Sep. 19, 2002

(54) Method for time controlled gambling games

(76) Inventor: William A. Taylor, Evergreen, CO (US)

Correspondence Address: SHERIDAN ROSS PC, 1560 BROADWAY, SUITE 1200, DENVER, CO, 80202

(21) Appl. No.: 10/095,795

(22) Filed: Mar. 11, 2002

Related U.S. Application Data
(60) Provisional application No. 60/275,128, filed on Mar. 13, 2001.

(51) Int. Cl. A63F 13/00

(52) U.S. Cl. 463/16

(57) ABSTRACT

A method for wagering on a gaming device where players purchase time on the device as opposed to an individual game. Within the pre-purchased time period, players are allowed to play as many individual games as possible to maximize their returns. In one preferred embodiment, winnings are retained and accumulated without requiring additional wagers. Players may also win or purchase additional time or make additional wagers during the pre-purchased time period.

This application claims priority of U.S. Provisional Patent Application Ser. No. 60/275,128 entitled “Wagering Method for Gambling Games”, having a filing date of Mar. 13, 2001, the application being incorporated herein by reference in its entirety.

### FIELD OF THE INVENTION

The invention relates to gaming machines generally, and in particular to methods of wagering on gambling devices for a predetermined period of time.

### BACKGROUND OF THE INVENTION

Gambling devices, such as slot machines, allow players to wager something of value in the hopes of winning something of greater value. Originally slot machines were mechanical devices employing 3 physical reels with various symbols painted or affixed to them. Upon inserting a coin and pulling a springloaded handle, the reels were set in motion and players were paid (or not) depending upon where the reels stopped and which symbols were displayed across the display portion of the machine.

Slot machines have evolved greatly since the original gaming devices discussed above. Most slot machines utilized today are electronic computers, and the symbols are displayed in video form. Players increasingly prefer video display slot machines over the traditional slot machines using mechanical reels. The video platform also offers more flexibility in development for manufacturers. The common term today for a gambling machine is a “gaming device”, and is used herein to include slot machines, video poker, and other gambling games whether reel, video or otherwise.

Newer video slots typically display 5 reels side-by-side that spin on a common axis instead of the traditional 3 (or more) mechanical reels. These newer video slots usually show 3 stopping positions of each reel yielding a visible matrix of 3 rows by 5 columns. Sometimes the number of reels and reel positions displayed differ.

Players typically wager on 1 or more paylines that run in different paths through the reel positions displayed. Unlike newer models of gaming devices, early slots paid only for matching symbols straight across the center (a single payline). The path of each payline usually takes 1 adjacent position of each reel, so on a 5-reel game, the payline is usually 5 positions in length. Players may wager on multiple paylines and may even wager multiple credits per payline. Reel symbols occurring in various combinations on the paylines are compared to a payable to determine a win or loss. Often there are wild symbols that substitute for other symbols, and symbol combinations that trigger a bonus or feature game. Today, gaming machines may provide scattered pays, where certain symbol(s) pay anywhere in the visible display and are not required to occur on a payline. Wins are usually rewarded with monetary awards from a coin hopper provided in the machine.

Second screen features (or more) are now common. A bonus “second-screen” game is usually separate and distinct from the normal reel display, and a player might select a car in a car race or scratch from a selection of video lottery tickets to earn credits, free games or anything of value. Some games even offer third screens or more, enhancing player interest and intrigue.

Some players have found ways to play consecutive games without manual intervention. Sometimes players wedge a toothpick or folded matchbook cover in such a manner as to keep the play button depressed. Provided they have sufficient credits, consecutive games play off by themselves. Although these players have basically fashioned an autoplay device, each game is still a single, discrete event that requires a separate wager.

The problem with autoplay gambling devices is that they are not interactive. By definition, what autoplay offers players is the ability to gamble largely without human intervention described in U.S. Pat. Nos. 6,244,957 and 6,012,983 to Walker, et al. In fact, once started, an autoplay player need not even watch the game, much less become involved with it. In general, the more interactive a gaming device is, the greater its entertainment value, and the more entertaining a game is, the more players will play it. Autoplay does not offer the same excitement of playing manually. A serious shortcoming of autoplay-type games, is their lower entertainment value and the smaller set of players that would enjoy such a decidedly non-interactive gaming experience.

Other types of gaming devices offer side bets. For example, as disclosed in U.S. Pat. No. 6,283,474 to de Keller, players play blackjack, but may wager separately who gets closest to a “21” point score. Similarly, in US. Pat No. 6,019,374 to Breeding, a gaming device is provided which offers a side bet to participate in a super jackpot game. Side bets are just additional bets, and they are also discrete in that they are separate wagers on separate events.

Similarly, some gaming devices offer multiple bets. Triple play poker as described in U.S. Pat. No. 5,823,873 to Moody allows a player's held cards to be played as multiple poker hands with each draw performed independently, which usually results in 3 different outcomes. The drawback is each additional hand requires an additional wager, which can quickly become an expensive game for a typical player.

Regardless of the type or form of gaming device, whether reel slot, video game or some other type or combination, the method of wagering has remained largely the same for years. The player inserts coins or otherwise obtains credits on a machine, commits a wager and initiates play, and then is paid or not depending on the outcome. Although many new games are played today and new gaming-related methods and apparatus are being disclosed, the wagering methods are still based upon games that pay players directly in response to a single wager.

Slot machines today play in many different denominations. Credits on one machine might be worth 1 cent, while others are worth $100. Some machines today even allow you to select the denomination within the machine and to change it between games. One recent advance in slot machine technology has been the introduction of a credit meter. With a credit meter, a player could insert more coins than were needed to play a single game, and thus have a pool of funds to draw upon. Ten nickels inserted would yield ten credits, for example. Then, the player could play one game that required ten nickel credits, ten games that required one nickel credit each, or anything in between. The use of a credit meter also allowed winnings to be accumulated on the machine, instead of always being paid out in coins each time the player won. A player could rack up credits and then choose to cash out at their leisure by the use of a special button on the machine for this purpose.

In the 1980s and 1990s, slot machine manufacturers began adding currency acceptors to their machines. Players could now obtain machine credits by simply inserting paper currency. In recent years, manufacturers have even added devices that could dispense currency instead of, or in addition to, coins. (These are known as note hoppers and operate similar to bank cash machines or ATMs). Further, many newer machines pay players in paper tickets or scripts that may be redeemed elsewhere or reinserted into similar machines that read and accept such paper. These are usually known as ticket-printer machines. Some machines may even accept credit cards or other cards that have value.

As a promotion, casinos sometime configure certain slot machines for tournament play. Slot tournaments are player versus player competitions administered by casino staff. Players gain entry through a variety of means, such as achieving VIP status in the casino's players club, paying an entry fee or simply for signing up. In these tournaments, players do not wager anything directly or at all, but person(s) with the highest credit scores receive something of value from the casino. Since there is no wager, the slot machines are set to a free play mode where the goal is to get more credits than the other players. Players are not paid directly for credits earned. Tournaments are marketing programs and not gaming devices, but they are important because they generate enormous excitement in players, who play as fast as they can.

Tournaments can also be an inconvenient hassle. They're only offered at certain times—if you can't be there at the right time, you can't play. They require staff oversight for setup and administration. Again, tournaments are marketing promotions and not self-managing gaming devices. Tournaments are also heavily marketed, which means a lot of hype and attention is focused on player participants and onlookers. This can be intimidating for those who prefer to play solo and/or out of the limelight.

Although many methods exist today for the player to obtain credits or otherwise enable a slot machine for play and a player may have many credits at their disposal at any point in time, each game is a single and discrete event that is initiated one at a time, usually by pressing a button or pulling a handle. Even games that offer more free games as an embedded feature within the game, or games that offer side bets are wagered one at a time. Each game costs a certain amount to play and unless a player has sufficient credits available, another game cannot be played, thus extremely limiting the time allowed on a particular gaming device.

Time on a particular device is a huge factor in the gaming industry today. Time on device is important not only for direct profits to gaming device operators, but also indirectly. The more time spent in one gambling property means more profit opportunities for the casino. Restaurants, shows, gift shops, hotel rooms, etc., all give the casino the chance for more profits. In general, the more time a player spends in a gaming establishment, the greater the likelihood they will return to spend additional money. Operators strive to keep you in their establishment, which generally means more profits, and typically provide numerous incentives such as free or inexpensive food and drinks specifically for this purpose.

Marketing studies have revealed that players do not mind losing so much, as long as they can have a good time playing. Most casino gamblers don't really expect to win, but they do expect to play for a reasonable amount of time. This is entirely consistent with the gaming philosophy wherein gaming for the typical patron is more of an entertainment experience than a hardcore gambling experience. With the proliferation of casinos in America over the past 20 years, casino gambling has become mainstream entertainment. Perhaps the most important part of that entertainment value is “time on device”, or how long you get to play for your money. Thus, time on device is critical to a positive gambling experience.

Accordingly, recent attempts have been made to ensure greater time on device for players. Perhaps the most common method today on slot machines is to employ a very high mathematical hit frequency and a reduced payable. Especially in the newer video slots, hit frequencies reach 70% or more. In practice, this means you might bet 10 coins per line on 9 paylines (90 coins total) only to win 20 coins. Even though this is clearly a net loss for the player, the 20 is still advertised as a win. This trickling back of credits to the player takes their money more slowly, recognizes them as winners (even if they're losing) and extends their play time for a given amount of money to bet.

One problem with high hit frequencies is that player returns become meaningless. While time on device is generally lengthened, betting 90 to win 20 eventually becomes tedious and boring. Players are not ignorant and do realize that in these types of gaming products, they are not really winning, even if the machine displays “winner”, but rather—they have simply lost less. The reduced payable means the allure of big winners is diminished. The tradeoff of more common winners is smaller winners.

Another problem of multi-line, multiple coin-per-line games is confusing math. For example, you might bet 4 coins per line on 7 paylines of a nickel game and win 2 for 1 on payline 3 and 3 for 1 on payline 6. How much is that? Well, that's a 28 nickel bet ($1.40) and winnings of 8 nickels plus 12 nickels ($1.00). The bottom line in this example is that the player has lost. That type of gaming configuration is confusing to most players, and figuring this out can slow down or significantly reduce play.

The gaming industry recognizes the need for greater time on device, but has not identified a practical or cost effective method of how to provide it. Generating time on device is very important to Harrah's™, one of the big Nevada casino operators, who will refund your first 30 minutes of slot losses under a program they call “Play an Hour on Us.” This program is offered when players sign up for Harrah's™ “Total Rewards” players club card. Obviously, this program is designed to promote time on device. There are many problems with this approach, but it shows how important it is for casino operators to elicit time on device from players.

Harrah's™ method is neither convenient for players or the casino. First players have to sign up with a casino marketing database which takes time. Subsequently a player is issued a player's club card that must be saved, carried and inserted into the slot machine while playing. Then a claim must be filed. It might take weeks to receive a reimbursement check, so these funds are not immediately available for rewagering. For the casino, this means establishing a player's club, adding card readers, networking the slot machines, maintaining huge tracking databases, employing additional personnel, and finally, giving up one-half hour's worth of potential slot machine earnings for every player enrolled. This method is thus time consuming and burdensome for the casino and players which utilize the casinos facilities.

Clearly the need exists for a straightforward means to provide a cost effective gaming device which guarantees a certain amount of time for a player, which is described hereinbelow:

### SUMMARY OF THE INVENTION

Accordingly, it is one aspect of the present invention to provide a guaranteed amount of playing time on a gaming device. Unlike the complicated methods used in the past to secure greater time on device, this invention is straightforward and easily implemented and additional game time may be won or extended based on a player's success.

The present invention thus promotes player interaction and once initiated, is not “credit” dependent. Thus, this invention is much better than an autoplay device, which is really no better than wedging a toothpick in a play button of an electronic video slot machine. Further, in another aspect of the present invention, a player is only required to make a single wager to play multiple games. This is a significant improvement over games offering side bets or multiple bets, which require additional betting to receive more credits and hence time.

In another aspect of the present invention, the players are allowed to keep all their winnings during the purchased game time. It thus incorporates all of the thrills of a slot tournament promotion without staff administration. In a preferred embodiment, you do not compete against other players, but you play directly against the house and the player keeps all of the winnings.

Furthermore, the present invention simplifies betting and payouts. In the preferred embodiment, all paylines are automatically covered and the payouts are in dollars, so there is less confusing math of credit multipliers for players to deal with and attempt to understand. This methodology simplifies and speeds play; and promotes a favorable gaming experience for players.

In another aspect of the present invention, a skill component is added to traditional gaming experience. To get the most games possible per unit of time, players must initiate games as fast as possible. A faster player may obtain more games than a slower player within the allotted time frame. This may satisfy the requirement that skill be used to assist in the outcome. Games involving skill are required for approval in certain gaming jurisdictions.

It is another aspect of the present invention that the gaming experience be highly interactive. Thus, the game requires players to be there physically to start each and every game within the purchased time period to get the most for their money. This interaction insures a higher level of player involvement.

Furthermore, the present invention can be applied to nearly any existing gaming device. It is relatively easy to retrofit existing slot machines by use of an appropriate timing means, and by pricing play time (the wager) appropriately to achieve an acceptable profit to operators and an acceptable return to players. Accordingly, existing play methods, except for the wager, can remain unchanged and thus are cost effective for casinos.

It is another aspect of the present invention that the device be useful in gaming markets where “loss limits” are in effect. In the Netherlands, for example, games must be designed so that the expected loss rate does not exceed 50 guilders per hour. Thus, this invention can simplify regulatory compliance with time standards and loss limits in certain gaming jurisdictions.

It is another aspect of the present invention that the gaming methodology may be useful in dealing with problem gamblers. Thus, by defining in advance the cost of play for a given period, players are less likely to get carried away with their betting. Today it is often difficult for players to assess the cost of playing over extended periods of time, since that requires timing individual games, monitoring play rates and tracking wagers that casual players are ill-equipped to do. In fact, electronic devices to assist players are generally prohibited by casino operators. With this invention, a player's monetary risk over time is clearly known in advance. These features could minimize a casino operator's liability for problem gamblers, as well.

It is thus an additional aspect of the present invention to lessen a player's risk for the same amount of play, yet provide the same earnings to casino operators. These benefits as compared to a traditional slot machine game are shown in the following example:

Player #1. Some slot machines keep, on average, 10% of monies wagered. If $5 per game is wagered on such a game, and a game takes 5 seconds to play, then player #1 will lose 10% of $5 times 12, or $6.00 each minute on average. Note player #1 has risked a total of $5 each for 12 games, or a total of $60.

Player #2. With the method of the present using this invention, player #2 bets $20 one time only for one minute of play. The slot machine loss rate is adjusted such that, on average, the casino keeps $6 from each minute of play. So, after one minute, player #2 has also lost $6.00.

Results. Both players have lost $6.00. The casino has won the same amount in the same amount of time. However, (A) Player #1's risk was 3 times greater than player #2—$60 vs. $20; and (B) Player #2 has enjoyed longer guaranteed play time—at least 60 seconds. Player #1 could lose $20 in as little as 4 games (taking just 20 seconds).

In another aspect, the present invention offers a player the chance to win additional play time. In an alternative embodiment, extended play time is granted for getting certain symbols. Unlike simply winning free games, which usually play off automatically, this method of extended play time adds urgency and a skill component, leading to greater excitement.

In another aspect, the present invention lets a player accumulate their winnings. Further it does not cost anything additional to play the next game within the pre-purchased time cycle. All wins are retained and accumulated and are thus not dwindled away by additional bet requirements.

Further, the present invention lets players more easily evaluate their wins or losses over a period of time. At the end of their purchased time period, players may easily compare their investment to their final return. This is not always easy to do when continually feeding in coins and currency, and playing off credits won from the credit meter. Thus, the gaming experience is less complicated and easier for players to understand.

Furthermore, the present invention strengthens a player's self image. In recent years, the percentage of a casino's floor devoted to lower denomination machines has increased drastically due to the proliferation of multi-line, multiple coin-per-line video slots. Dollar denominated slot players hold greater esteem than nickel players. While 90-coin nickel players might bet $4.50 per game and $50 per minute or more, they're still perceived as lowly nickel players. Since this invention will usually require a greater initial wager ($20 in the preferred embodiment), but usually less over time, it restores and enhances the psychological self-image of the high roller at a reasonable price.

Finally, it is another embodiment of the present invention to minimize coin handling and speed game play. In one embodiment, this invention requires only a single bet for 1 minute of play. Traditional games today play in under 5 seconds each, so there are potentially 12 or more bets per minute! If not enough credits are available, play is slowed by adding coins or currency. In the preferred embodiment, the bet decision is only made once per minute, so players can focus less on paying and inserting coins and more on playing. Thus, the gaming experience is easier and faster to play.

### BRIEF DESCRIPTION OF THE DRAWINGS

FIG. 1 is a front elevation view of a video gaming device incorporating the present invention;

FIG. 2 shows an example of the play buttons in one embodiment of the present invention;

FIG. 3 depicts one embodiment of a screen display that might be used on a video gaming device which incorporates the present invention;

FIG. 4 depicts a screen display for an alternative embodiment of the present invention; and

FIG. 5 depicts another screen display for yet a further embodiment of the present invention; and

FIG. 6 is a flow diagram of one embodiment of the present invention.

### DETAILED DESCRIPTION

The present invention employs a unique and novel method of wagering on slot machines and other gaming devices. Instead of a player purchasing single games individually with coin, credit or other means, a player buys time. For example, inserting $20 into the machine buys one minute of play. During this minute, the player can play as many games as they can, which thus promotes an enhanced speed of play, opportunity for greater player interaction and hence an improved gaming experience. By purchasing time on the gaming device instead of individual games, there is no longer a direct relationship between a single game and the wager. Thus, the present invention guarantees time on device. By purchasing time on a gaming device instead of individual games, players are assured of a certain length of play.

In one embodiment, the current invention incorporates the following methodology.

a) A player inserts a $20 bill into a slot machine, and 20 dollar credits are posted to the machine credit meter.

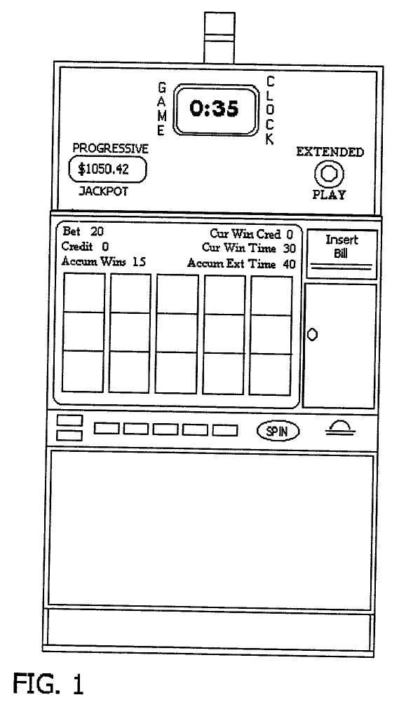

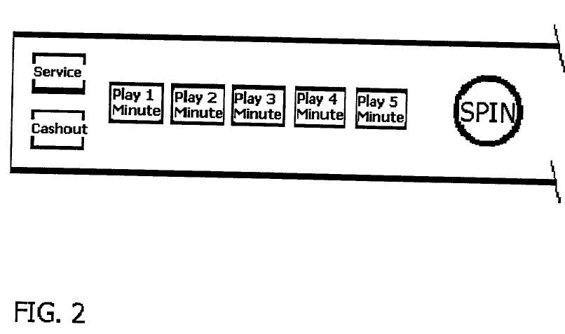

b) The player presses the lighted button #1 labeled “Play 1 Minute” (see FIG. 2). Twenty credits are deducted from the credit meter leaving a balance of 0. A conspicuously displayed clock timer resets to a full 60 seconds. The player presses a prominent spin button, the timer begins counting down and the reels spin. All reels spin and stop sequentially approximately 5 seconds later. The resting symbols displayed are evaluated against a paytable to determine any winners. The clock timer continues to run non-stop the entire time. Winnings, if any, are posted to a current win meter and are also accumulated on an accumulated win meter. The player presses the spin button again initiating the next game, and the cycle repeats until the game clock expires, evidenced by a display of 0:00 on the game clock. When the last game started before time expires is finished, accumulated winnings are posted to the credit meter and are available for rewagering or cash out. For an example of one embodiment of a typical visual display and associated clock and activation buttons, refer to FIG. 1.

Games which are initiated before time expires are normally allowed to finish, and will subsequently pay a player according to the paytable as necessary. Further, all events within the time cycle may be accompanied by suitable audio or video effects such as flashing lights, horns, bells, whistles, etc.

With a fixed amount of time for play, players are motivated to play as fast as they can. This enhances the gaming experience and hence encourages more play and enhanced revenues for the gaming establishment. When a player buys time, they are effectively making a commitment to buy multiple games of a traditional nature. Players will typically start their next game as soon as one ends to get the most games for their money, and may develop different methods in this pursuit. Some players may repeatedly press the spin button hoping to catch it at the earliest opportunity, while others may wait until the reels land and are evaluated before pressing it again. These methods comprise a skill component. The frenzied style of play adds excitement and greater entertainment value to the gaming experience. As play time nears expiration, audio ticks may increase in volume, and the video machine background may change color, signaling to the player their time is nearly up. Finally, a bell or similar signal sounds when time expires and play is finished. As appreciated by one skilled in the art, any combination of audio or visual enhancements may be utilized during the time of play, or subsequently thereafter which indicates a successful wagering experience or other factors related thereto.

At the conclusion of play time, the player can evaluate their winnings against their wager, and they are free to purchase more time by any acceptable means, or to cash out, meaning take any winnings and discontinue additional play. In this invention, note the player only made one wager which earned them the player the right to play as many games as they could within the allotted time period.

In one alternative embodiment of the present invention, the game is provided with a feature that offers additional play time. For example, the paytable includes a “scatter pay” that triggers extended play time for 3 or more of a specified symbol landing anywhere onscreen. The extended play time may typically pay 10 seconds for 3 of the symbols, 20 seconds for 4 of the symbols and 30 seconds of additional play time for 5 of the symbols. The extended play time is accumulated on a separate, extended play meter and, upon the expiration of the originally pre-purchased time period, is posted to the game clock and used immediately without any further action by the player.

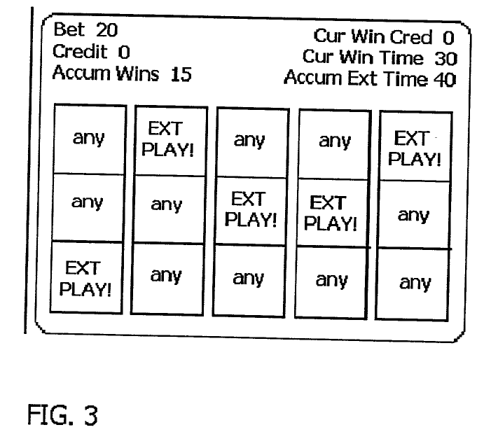

Referring now to FIG. 3, consider a player buying 1 minute of play for $20 and on their 3rd spin getting a 3 symbol scatter win that pays 10 seconds of extended play time. On their 4th spin, they win 15 credits. Further, on their 5th spin they get a 5 symbol scatter pay that pays 30 seconds of extended play time. At this point as illustrated in FIG. 3, 40 seconds are accumulated and displayed on the accumulated extended time meter. At the end of regular play, this 40 seconds is posted to the game clock, the 40 seconds is removed from the extended play meter and play continues uninterrupted for another 40 seconds. Note it is possible to achieve yet another scatter pay winner during these 40 seconds that grants more extended play time, whereupon the cycle repeats. In other words, it is possible to win more extended play while you are in an extended play period.

Of course, extended play may be accompanied by appropriate audio and video changes such as flashing lights to enhance the extended play experience. An optional extended play light is shown in FIG. 1.

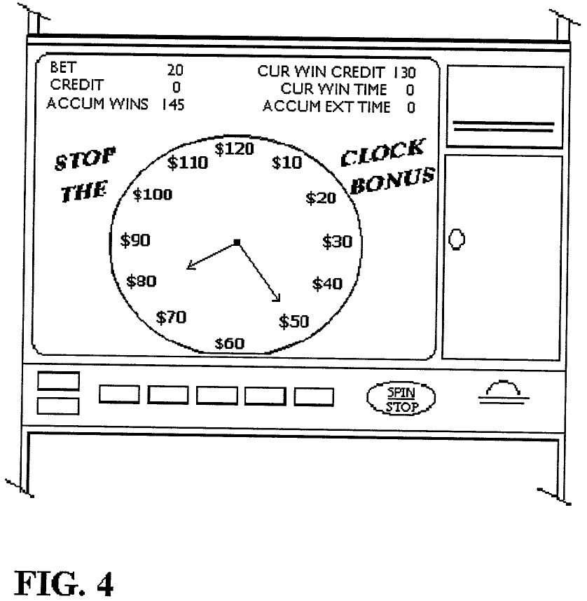

In a second alternative of the present invention, a method is provided wherein a bonus game is embedded within the base game. Here, a scatter pay of 3 or more special symbols (clocks, for example) appearing anywhere onscreen in the base game triggers a second-screen feature game. Upon triggering the feature, the base game timer stops temporarily, so there is no time penalty for playing the bonus. In the bonus, there is a large clock with credit values or dollar values of any amount replacing the time numerals. Hand/s of the clock spin rapidly (or are set spinning by pressing start). Pressing a button designated as the stop button stops the hand/s, and the player is paid according to which value the hand/s are pointing at. After posting any winnings to the credit meter, base game play is resumed and the base game timer continues its count down from where it left off. One example of this particular embodiment is shown in FIG. 4.

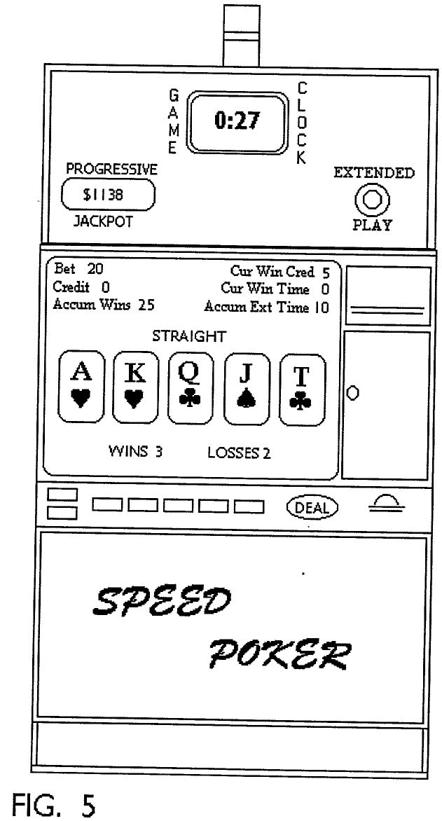

In a third embodiment of the present invention, and referring now to FIG. 5, time may be sold for use with a video draw poker gaming device. Instead of wagering on individual (or multiple) hands of video poker, in this game, referred to as “Speed Poker”, players purchase time on the video poker device and play as many hands of video draw poker as possible within the allotted time frame. Since draw poker alone inherently requires skill, adding a time constraint may be especially intriguing to the accomplished player. Extended play time, second-screen feature games or other bonuses may be granted for achieving certain cards or hands, a certain number of winning (or losing) hands or even randomly within the pre-purchased time period.

In a fourth alternative embodiment to the present invention a time-based jackpot, predetermined or progressive, may be offered. For example, a player may be rewarded with additional time or credits for achieving 10 consecutive wins within their pre-purchased minute of play. Alternatively, a consolation prize may be awarded for 10 consecutive losers! Additional play time may be granted on a random or pseudo-random basis. In a typical progressive jackpot fashion, a paytable may include awards that increase in value depending upon the length of time they have gone uncollected. For example, obtaining 5 green clover symbols might normally pay a fixed award of $100. With a time-based progressive, that award might increase by $1 for every minute played on the gaming device where it is not won. Depending upon the mathematical hit frequency of the game, this progressive jackpot might have an expected value at payoff of $150 or so. When it does hit, it automatically resets to its starting value of $100 and starts incrementing all over again. A similar progressive jackpot display example is shown in FIG. 1 in the upper left hand corner of the gaming device

In a fifth alternative of the present invention, the pre-purchased time period may be variable. The precise length of play granted for a player's wager may in fact be a gamble of it's own. That is, a player might receive either 60 seconds or 90 seconds of play time for the same wager. Another example of a variable time period wager might employ a special termination feature in the game. On a slot machine, the initial wager might enable play for an indeterminate length of time, with play ending only after the player has accumulated 5 time bomb symbols over the course of 2 or more games. On a draw poker machine, play might terminate only when the player has drawn the queen of spades three times. In these embodiments, we might even include special “undo” symbols that takes accumulated time bomb/s or said queens away.

Most gambling games in casinos today can use this invention with a timer means and appropriate software, firmware or hardware means. The purchase of time on device instead of buying a game or games, can be employed in innumerable gambling situations. It can be offered in virtually any slot machine, whether mechanical, video reel or otherwise. It works equally well in video poker, video blackjack and other gaming devices.

The time purchased can be infinitely adjusted from 1 second to 1 hour, or more. The cost of play time (the wager) can also be infinitely adjusted, depending upon the nature of the game, from $0 to $100 or more. There is no requirement that this invention yield the house or player the same mathematical advantage as any other game, but rather this advantage can be greater, equal to or less than any like or dissimilar gambling device. In fact, there may be no mathematical advantage at all, and various embodiments of this invention may be used as a promotional means.

The nature of the clock function means for timekeeping can also be varied. The game count-down clock can easily be replaced by any device measuring time as in a digital display, LED, video clock, periodic audio (tick tocks or gongs), hourglass or other means.

The only requirement of this invention is that players wager by purchasing playing time instead of one (or more) individual games.

The physical workings of the devices incorporating the invention and embodiments herein are as follows. First, there is an enclosure which contains the component parts of the gaming device. The enclosure is a secured cabinet usually made of steel and typically offered in 3 styles: the traditional upright cabinet, the slant top cabinet intended only for seated play and the bar top which is fitted into a special cavity in a pre-existing bar. The enclosure and components together comprise a self-contained gaming device. A front view of an upright gaming device is shown in FIG. 1 and FIG. 5.

The cabinet enclosure is fitted with various input and output means. Inputs may be accomplished by inserting coins or currency, by inserting credit or player's club cards or by pressing buttons or touchscreen panels. Output means include bells and lights (audio and video), coin or currency dispensing functions and video monitor or reel displays. Various input and output means are described herein.

A computer storage means such as a hard drive is typically locked inside of the cabinet and is not physically accessible to players. This computer hard drive stores critical game information such as the game program itself, random number generation means, game results and accumulated statistics. Other common computer data storage means are often used in addition to or instead of a hard drive. For example, critical logic and storage functions may be performed by or in conjunction with a CD-Rom drive, PROM (programmable read-only memory), promdisk (a computer chip that acts as a hard drive), RAM (random access memory) or other means.

Newer gaming devices may accept credit cards, or encoded player cards as legal tender acceptance means. In these cases a card reader is secured inside the cabinet in such a manner so that players may insert their cards from the device exterior. Credits may be deducted from the card's balance and posted to the gaming device, enabling it for play. Player card balances are often increased depending on the amount of game play. For example, a player might earn $5 for every $1000 wagered through participation in a casino's player's club, and that $5 may be posted to a player's card directly. Winnings may also be posted to a player's card.

A display monitor is also secured inside the cabinet so to be visible to the player. The display monitor is primarily an output device, or a means to report game results to players. However, in the case of newer machines, a monitor may be fitted with a touchscreen device that acts as an input medium. Players may thereby make their wagers or other game selections by touch instead of by button. Not all gaming devices are in video form, however, and mechanical reels or other means may replace a display monitor as an output device.

This invention employs a clock or timing means. A traditional clock, digital timer or other means may be built into the device enclosure to time game play and report time remaining to players. (See the game clock in FIG. 1 and FIG. 5.) Alternatively, said timing means may be displayed on the video monitor.

Another output function relates to dispensing wins. Most gaming devices include a coin hopper mounted inside the enclosure to receive and payout coins or tokens. Pressing the cashout button (or the appropriate cashout indicator displayed on touchscreen) results in machine credits being paid out of the gaming device in coins or tokens or by other means.

Note that many new games now are referred to as “ticket in, ticket out”, such that legal tender acceptance means includes the acceptance of paper vouchers. Similarly, ticket printers may provide credit dispensing means.

Thus, the gaming device generally comprises an enclosure or cabinet that is generally secured by lock(s) to prevent internal access by players. Upon inserting suitable legal tender or its equivalent into a legal tender receiving means, credits are posted onto the gaming device. These credits are displayed on an output means, usually a video display monitor, but sometimes an LED or similar display. Touching appropriate buttons make game selections and initiate play. A random number generation program is called which selects an outcome, and that outcome is stored in a data storage means and displayed to the player on a video display or by other type of device according to the nature of the game. Often there are opportunities to improve the outcome as in an embodiment incorporating rules of video poker, or as in other forms of this invention whereby additional games may be played without rewagering. Sometimes there are secondary event or bonus features that require additional player input(s). When the game or game cycle is ultimately resolved, wins, if any, are posted to the credit meter and are available for rewagering or cashout.

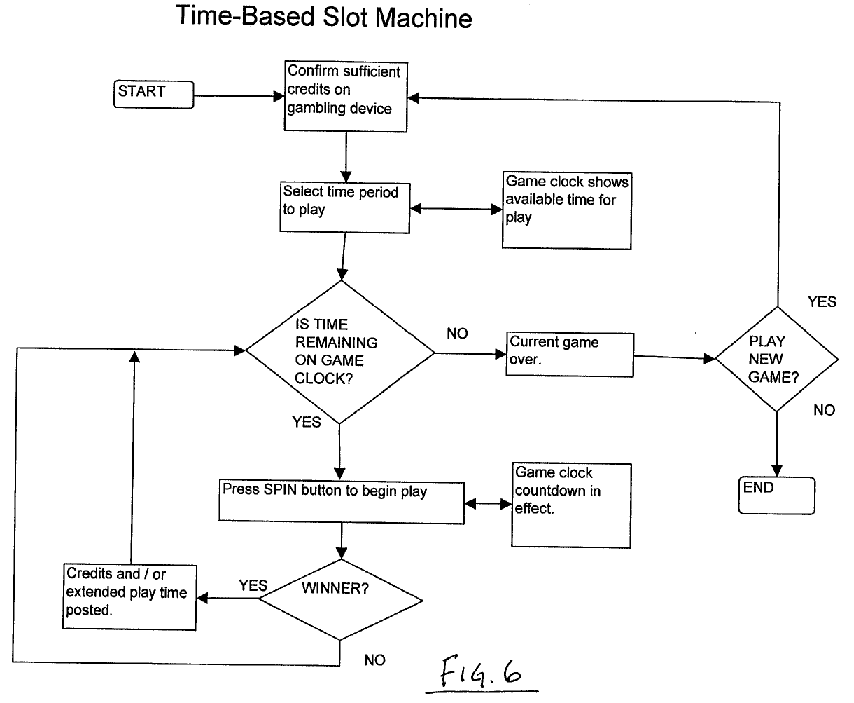

Referring now to FIG. 6, a flowchart of one embodiment of the present invention is provided herein. As shown, the player of the gambling game inserts legal tender in the form of coins, a credit card, or other means to obtain sufficient credit to play the game. A time period to play the gambling game is then selected or may be determined automatically by the total amount of money or credit provided. The user then plays the game as quickly or slowly as desired, although speed will generally allow the user to play the game numerous times and in rapid succession for a given amount of credit, as shown by pressing the SPIN button to begin another game. Once the time clock runs out, the user may be rewarded a prize such as a monetary payout, or receive credits for an extended period of play. Thus, unlike prior art gambling games, the frequency of play of the gambling games of the present invention is driven solely by a period of time and a level of skill and speed of the participant. In an alternative embodiment, the clock and time of play may be suspended for a predetermined period of time and/or may be reset.

While this invention is illustrated with respect to several specific embodiments thereof, these should be considered illustrative rather than limiting. The embodiments shown may be combined or modified to create other games or to involve other methods that remain within the scope of this specification. For example, a double scatter pay may be employed such that one set of symbols grants the aforementioned extended play time and another grants the aforementioned second-screen clock feature. Side bets, multiple bets or additional time may also be purchased before, during or after the purchased time cycle. This description is not intended to be an exhaustive discussion of the many possible uses of this invention. A person of normal skill in the art can envision many possible uses of this invention beyond those specifically identified herein.

What is claimed is:

1. A method of playing a gaming machine, comprising the steps of:
a) initiating a selected time period of play for a gambling game operating on said gaming machine;
b) displaying a plurality of parameters related to said gambling game on a video monitor;
c) interacting with a player of said gambling game from data selectively entered by the player on a plurality of touch sensitive buttons;
d) determining an outcome of said gambling game based on data provided in a storage means of said gaming machine; and
e) displaying a game result based on said outcome of said predetermined game.

2. The method of claim 1, wherein said storage means comprises a computer hard drive.

3. The method of claim 1, further comprising the step of providing a subsequent period of time to play said gambling game based on said outcome of said predetermined game.

4. The method of claim 3, wherein said subsequent period of time to play is variable based on at least one of a plurality of possible factors.

5. The method of claim 1, wherein said initiating a selected time period of play step may be selectively altered based on at least one of a fee and a period of time.

6. The method of claim 1, wherein said selected time periods are temporarily suspended to permit player interaction without a time penalty based on at least one of a plurality of possible events.

7. The method of claim 1, wherein said selected time period is temporarily suspended to permit additional wagering without a time penalty.

8. The method of claim 1, wherein a plurality of gambling machines are interconnected and in operable communication to provide competition between a plurality of players.

9. The method of claim 1, further comprising the step of providing a time-based progressive jackpot which increases potential earnings as time increases on said predetermined game.

10. The method of claim 1, wherein a minimum number of said gambling games played within said selected time period is at least two.

11. The method of claim 3, wherein said subsequent period of time to play is initiated after a predetermined delay, during which time a timing function is temporarily suspended.

12. The method of claim 3, wherein said subsequent period of time to play is obtained by providing an additional wager.

13. The method of claim 3 wherein a second subsequent period of time to play is awarded while in said subsequent period of time to play if at least one of a predetermined number of possible events is achieved.

14. The method of claim 1, further comprising the step of providing a payment means based on said determining an outcome step.

15. An apparatus for operating a gaming program based on a predetermined period of time, comprising:
an enclosure;
a data storage means for storing said gaming program which is operably positioned within said enclosure;
at least one access slot operably interconnected to said enclosure for receiving a form of legal tender and initiating said gaming program;
a plurality of touch activated buttons operably interconnected to said enclosure for allowing a user to make a selection related to playing said gaming program;
a monitor for displaying data related to said software gaming program;
a timer for monitoring and controlling a time period of play allowed for said software gaming program, wherein a player of said apparatus may play said gaming program a variable number of ties based on said time period and a level of skill.

16. The apparatus of claim 15, wherein said data storage means comprises a computer hard drive.

17. The apparatus of claim 15, further comprising a means for dispensing a reward based on a given outcome of said gaming program.

18. The apparatus of claim 15, further comprising a means for selectively modifying said gaming program to adjust one of a plurality of possible parameters.

19. The apparatus of claim 18, wherein said plurality of possible parameters is at least one of a new fee to play, a new period of time to play, a number of users and a modification of said data storage means.

20. A method for playing a gaming device comprising the steps of:
a) providing a gaming machine comprising:
a data storage means;
a clock means to monitor and control a predetermined period of time said gaming device may be played;
a video display means;
a legal tender receiving means;
a data input means;
b) activating a gaming program stored in said data storage means by providing a predetermined amount of legal tender in said legal tender receiving means;
c) running said gaming program successively for a predetermined period of time, wherein a frequency of play is determined by a skill level and a speed of play of a user of said gaming device; and
d) initiating an award if a predetermined event occurs within said gaming program.

21. The method of claim 20, wherein said award comprises extending play on said gaming program for a subsequent predetermined period of time.

22. The method of claim 20, wherein said data input means comprises a plurality of touch sensitive buttons.

23. The method of claim 20, further comprising the step of interconnecting said gaming device with at least one other gaming device, wherein at least two players can interact and compete with each other.

24. A computer implemented method for playing a time-controlled gambling game, said computer having an associated memory, the method comprising the steps of:
providing a pay means to receive a form of legal tender to obtain a credit to allow play of said time controlled gambling game;
providing display means for displaying a gambling game portion which requires input by a user to initiate and interact with said gambling game;
providing a clock means to control a total time of play of said gambling game based on said credit;
storing in said memory said gambling game, said memory including a database which includes a probability of success of said gambling game;
allowing said user to play said time-controlled gambling game for a successive number of times based on a proficiency and a speed of play of the user;
providing an outcome of said gambling game on said display means.
